(19) United States
(12) Patent Application Publication
(10) Pub. No.: US 2016/0169155 A1
(43) Pub. Date: Jun. 16, 2016

(54) DEVICE FOR CONNECTING TWO SEGMENTS OF A PROPELLING NOZZLE

(71) Applicant: SNECMA, Paris (FR)

(72) Inventors: Dominique INDERSIE, Vernon (FR); Didier GUICHARD, Menilles (FR)

(73) Assignee: SNECMA, Paris (FR)

(21) Appl. No.: 14/902,141

(22) PCT Filed: Jul. 2, 2014
(86) PCT No.: PCT/FR2014/051700

§ 371 Date: Dec. 30, 2015

(30) Foreign Application Priority Data
Jul. 4, 2013 (FR) 1356554

(51) Int. Cl. F02K 1/40; B23P 15/00

(52) U.S. Cl. CPC F02K 1/40; B23P 15/008

(57) ABSTRACT

The invention relates to the field of propulsion nozzles, and in particular to a device (105) for connecting together first and second segments (103a, 103b) of a propulsion nozzle that are made of thermally dissimilar materials. The device (105) comprises at least one pin (106) and an eccentric bushing (107). The pin (106) presents both a first axisymmetric surface (106a) that is to be housed in a radial orifice (108) of the first nozzle segment (103a) and also a second axisymmetric surface (106b) that is eccentric relative to said first axisymmetric surface (106a).

### BACKGROUND OF THE INVENTION

The present invention relates to the field of propulsion nozzles, and in particular the field of rocket engine nozzles. More specifically, the present invention relates to assembling a propulsion nozzle comprising first and second segments, said first and second segments being made of materials that are thermally dissimilar.

The term “propulsion nozzle” is used to mean a nozzle of a shape that is appropriate for producing thrust by accelerating a propulsive fluid in a direction opposite from the thrust direction. In the description below, the terms “upstream” and “downstream” are defined relative to the normal flow direction of the propulsive fluid through the nozzle, and the terms “inside” and “outside” indicate respectively the regions inside and outside the nozzle.

Propulsion nozzles may in particular be convergents, for fluids that are not compressible or that reach only subsonic speeds, or they may be convergent-divergent for propulsive fluids that are compressible and that reach supersonic speeds. Rocket engines normally have convergent-divergent propulsion nozzles located directly downstream from combustion chambers. The expansion of the hot combustion gas leaving the combustion chamber through the propulsion nozzle serves to convert the thermal energy of the gas into kinetic energy. Consequently, the propulsion nozzles of rocket engines are typically subjected to extreme thermal stresses, since they come directly into contact with such combustion gas.

Furthermore, in order to be able to increase the propelled payload, it is appropriate to lighten the nozzle as much as possible. To do this, one possibility is to use segments made of materials that differ as a function of the thermal and mechanical stresses acting on each segment. Thus, by way of example, an upstream segment of the nozzle may be made at least in part out of metal in order to better remove the heat that is transmitted to the walls of the nozzle by the combustion gas, while a downstream segment, and in particular a divergent segment of the nozzle, where the combustion gas is significantly less hot after expanding and accelerating beyond the speed of sound, may be made of a composite material that is lighter in weight for comparable mechanical strength.

The different thermal characteristics of such materials can nevertheless raise major drawbacks. In particular, the physical connection between the segments may be subjected to large thermal and mechanical stresses as a result of the dissimilar thermal properties of the materials of the two segments.

Thus, the different coefficients of thermal expansion may lead to major mechanical stresses on the connection between the two segments. Also, the difference between the thermal conductivities of the two materials can also give rise to large temperature differences in the proximity of the junction between the two segments.

### OBJECT AND SUMMARY OF THE INVENTION

In a first aspect, the present disclosure seeks to propose a device for connecting together a first segment and a second segment of a propulsion nozzle that are made of thermally dissimilar materials, which provides a mechanical connection that is very reliable between said nozzle segments even under high thermal stresses.

This object is achieved by the fact that the connection device includes at least one pin with a first axisymmetric surface that is to be housed in a radial orifice of the first nozzle segment and a second axisymmetric surface that is eccentric relative to said first axisymmetric surface, and at least one eccentric bushing presenting an inside axisymmetric surface complementary to the second axisymmetric surface of the pin and an outside axisymmetric surface, that is eccentric relative to said inside axisymmetric surface and that is to be housed in a radial orifice of the second nozzle segment. The radial orientation of the pin when housed in the orifices of the two nozzle segments in order to connect them together may avoid large temperature gradients even when the temperatures of the inside walls of the two nozzle segments are very different in the proximity of their junction. Furthermore, the eccentricity between the two axisymmetric surfaces of the pin, and also between the two axisymmetric surfaces of the bushing, make it possible to adjust the position of the first axisymmetric surface of the pin in a plane perpendicular to the pin relative to the outside position of the axisymmetric surface of the bushing, in order to connect together the two segments even if their radial orifices are not accurately in alignment, e.g. as a result of axial prestress that needs to be maintained between the two nozzle segments in order to ensure a constant mechanical connection between the nozzle segments.

In particular, the axes of symmetry of the inside and outside axisymmetric surfaces of the eccentric bushing may present substantially the same offset between them as between the axes of symmetry of the first and second axisymmetric surfaces of the pin. Thus, the eccentric bushing and the pin turning jointly enables the relative position of the radial orifices of the two segments to be adjusted only in a direction parallel to a central axis of the nozzle, without necessarily giving rise to a corresponding relative movement in a tangential direction.

In order to retain the pin after it has been put into place between the two nozzle segments, the connection device may further include at least one axial retention member for axially retaining said pin, possibly associated with members for fastening said axial retention member to one of said nozzle segments.

At least some of said axisymmetric surfaces may in particular be cylindrical, thereby facilitating fabrication and facilitating installation of the bushing and of the pin. Nevertheless, it is also possible to envisage using other axisymmetric shapes, e.g. frustoconical shapes.

The present disclosure also relates to a propulsion nozzle including first and second nozzle segments made of thermally dissimilar materials, each having a radial shoulder bearing against a corresponding radial shoulder of the other one of said segments, together with a plurality of radial orifices facing corresponding orifices in the other one of said segments, and a plurality of the above-mentioned connection devices, with the first axisymmetric surface of the pin of each of them being housed in one of said radial orifices of the first segment, and the respective eccentric bushing is housed in the corresponding radial orifice of the second segment, the second axisymmetric surface of the pin co-operating with the inside axisymmetric surface of the eccentric bushing. The connection devices may thus maintain axial prestress between the two segments so as to maintain a strong mechanical connection between the segments, even under high levels of vibration.

In order to retain the eccentric bushings inside the radial orifices of the second nozzle segment after the two segments have been assembled together, each eccentric bushing may be retained between an outer surface of the first nozzle segment and a shoulder in the radial orifice of the second nozzle segment in which the eccentric bushing is housed.

The present disclosure also relates to a rocket engine with such a propulsion nozzle.

A second aspect of the present disclosure relates to a method of connecting together a first segment and a second segment of a propulsion nozzle that are made of thermally dissimilar materials, each of said segments including a plurality of radial orifices. The method includes at least the following steps:

Firstly inserting eccentric bushings in the radial orifices of the second nozzle segment, each bushing presenting an inside axisymmetric surface, and an outside axisymmetric surface that is eccentric relative to said inside axisymmetric surface.

Thereafter, causing a radial shoulder of the first segment to press against a radial shoulder of the second segment, said radial orifices of the first segment being put into register with corresponding orifices among the radial orifices of the second segment.

Finally, inserting pins in the radial orifices, each pin presenting a first axisymmetric surface that is to be housed in a radial orifice of the first nozzle segment and a second axisymmetric surface of the same connection part, that is eccentric relative to the first axisymmetric surface and complementary to the inside axisymmetric surface of one of said eccentric bushings. The first axisymmetric surface of the pin is aligned with the radial orifice of the first nozzle segment by turning the pin and the eccentric bushing in the corresponding radial orifice of the second segment.

Thus, thanks to the eccentricity of the pin and of the bushing, it is possible to adapt the geometry of the connection device formed by each bushing-and-pin pair to different relative positions in the axial direction of the nozzle of the radial orifices of the first segment relative to the radial orifices of the second segment, thus at least maintaining prestress between the two segments in that direction.

In order to obtain accurate prestress between the two elements, the prestress may be applied by external tooling while bringing the radial shoulder of the first segment to bear against the radial shoulder of the second segment. By way of example, the external tooling may comprise traction fingers or clamps. Nevertheless, as an alternative, it is also possible to envisage applying the prestress by turning the pin and the eccentric bushing in the corresponding radial orifice of the second segment.

The method may also include an additional step of putting into place at least one axial retention member for axially retaining said pins, in order to retain them in the radial orifices of the nozzle segments.

### BRIEF DESCRIPTION OF THE DRAWINGS

The invention may be well understood and its advantages appear better on reading the following detailed description of an embodiment given by way of nonlimiting example. The description refers to the accompanying drawings, in which:

FIG. 1 is a partial schematic view in longitudinal section of a rocket engine comprising a nozzle made of two segments of thermally dissimilar materials;

FIG. 2A is a cutaway perspective view of the junction between the two nozzle segments connected together by a connection device according to a first embodiment;

FIG. 2B is an exploded perspective view of the FIG. 2A junction;

FIG. 3 is a perspective view of the bushing and of the pin of the connection device of FIG. 2;

FIG. 4 shows the two nozzle segments of FIG. 2 being brought to bear one against the other;

FIGS. 5A to 5C show the FIG. 2 connection device being adjusted by turning the bushing and the pin;

FIG. 6 is a cutaway perspective view of the junction between the two nozzle segments connected together by a connection device according to a second embodiment; and

FIG. 7 is a cutaway perspective view of the junction between the two nozzle segments connected together by a connection device according to a third embodiment.

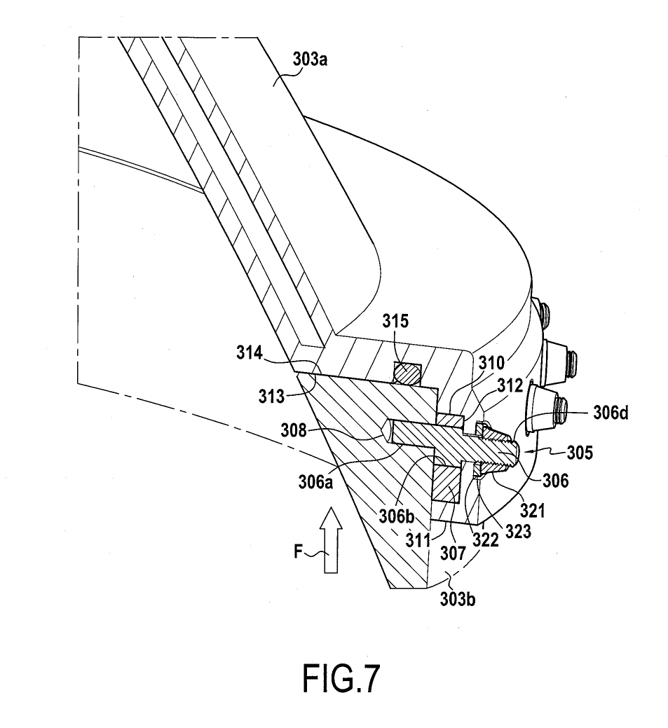

### DETAILED DESCRIPTION OF THE INVENTION

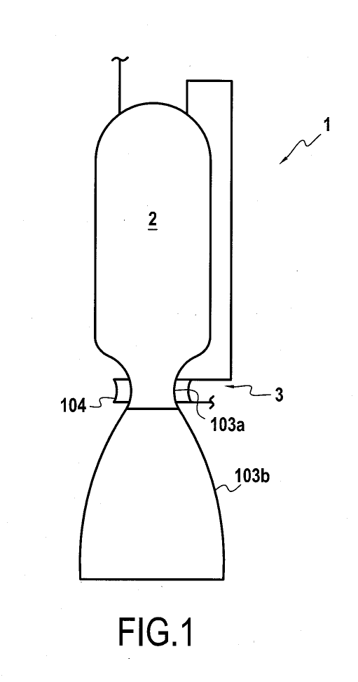

FIG. 1 shows a rocket engine 1 in part, and more specifically an assembly comprising a propulsion chamber formed by a combustion chamber 2 extended by a convergent-divergent nozzle 3. In order to lighten this assembly, the convergent-divergent nozzle 3 is made up of two segments 103a, 103b: a throat 103a and a divergent portion 103b. The throat 103a is formed integrally with the combustion chamber 2 that is made of high-temperature resistant metal material, and in the example shown, it presents regenerative cooling ducts 104 for exchanging heat with a propellant of the rocket engine 1. In contrast, the divergent portion 103b is made of composite material, e.g. a carbon/carbon (C/C) ceramic matrix composite, of the carbon silicon carbide (C-SiC), or of the silicon carbide silicon carbide (SiC-SiC) type, using fibers of carbon or of silicon carbide.

Because of the greater thermal conductivity of the metal material of the throat 103a, and because it is subjected to regenerative cooling by the propellant flowing through the ducts 104, the temperature of the throat 103a in the proximity of its junction with the divergent portion 103b may be substantially lower than the temperature of the divergent portion 103b in the same zone. Furthermore, the metal of the throat 103a normally presents a coefficient of thermal expansion that is substantially different from that of the composite material of the divergent portion 103b. This gives rise to particular stresses for the mechanical connection between these two segments 103a and 103b.

Thus, in a conventional connection using radial flanges together with bolts, during operation of the rocket engine, the bolts suffer firstly from high levels of shear stress because of the difference of thermal expansion between the two adjacent segments of the nozzle, and secondly from nonuniform heating that tends to expand the bolts and thus to loosen the connection. Such a connection is thus normally unsuitable for this application.

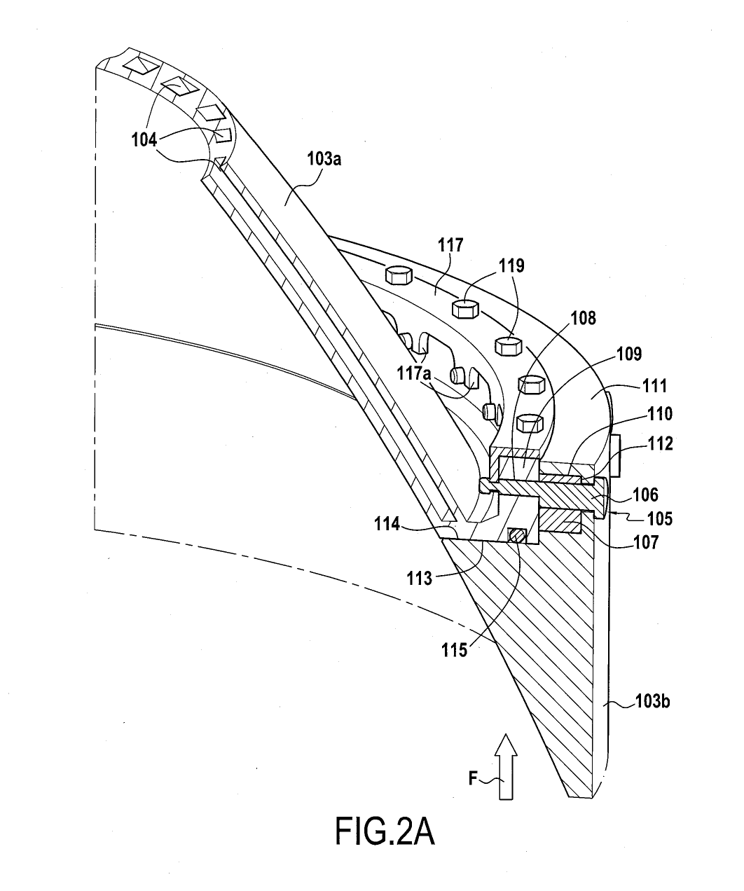

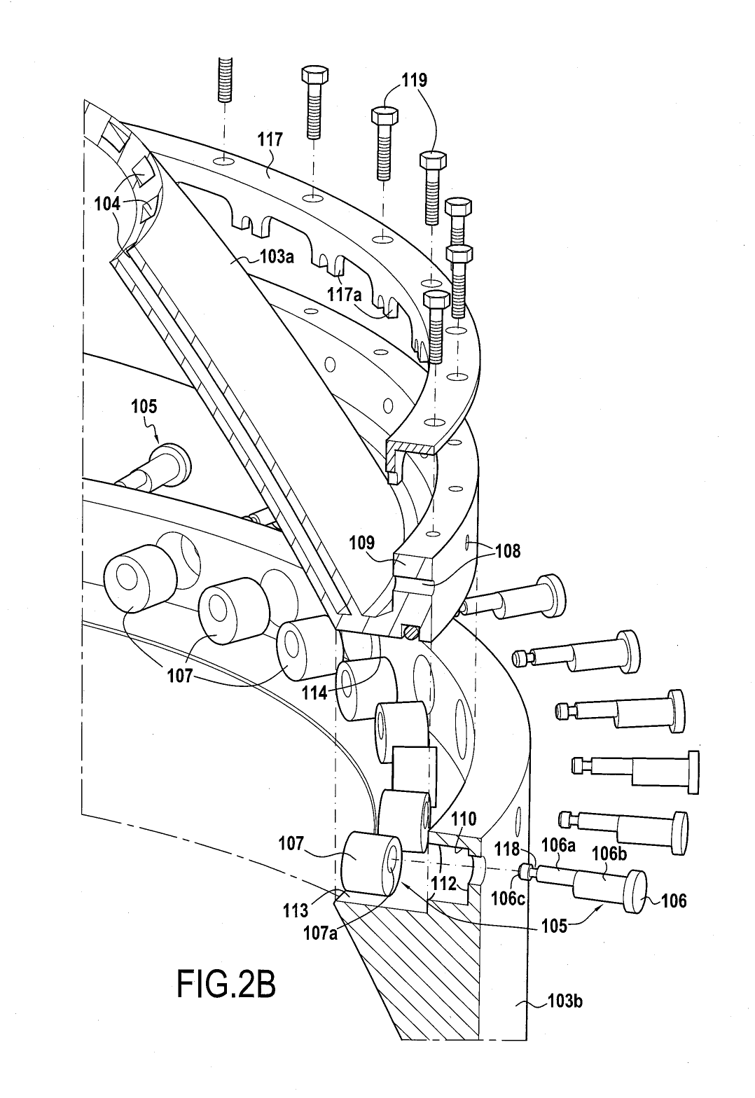

FIGS. 2A and 2B show a connection according to a first embodiment that seeks to solve those drawbacks. This connection between the throat 103a and the divergent portion 103b is provided by a series of connection devices 105, each comprising a pin 106 and a bushing 107, the devices being arranged all around the nozzle. These connection devices 105 maintain prestress F between a radial shoulder 113 of the divergent portion 103b pressing against a corresponding radial shoulder 114 of the throat 103a. A sealing ring 115 between these shoulders 113 and 114 provides sealing for the connection between the throat 103a and the divergent portion 103b. Each pin 106 is housed at one end in a radial orifice 108 in a ring 109 of the throat 103a, and at the other end inside the bushing 107, which is itself housed in a corresponding radial orifice 110 of a ring 111 of the divergent portion 103b. This radial orifice 110 presents a shoulder 112 against which the bushing 107 comes into abutment.

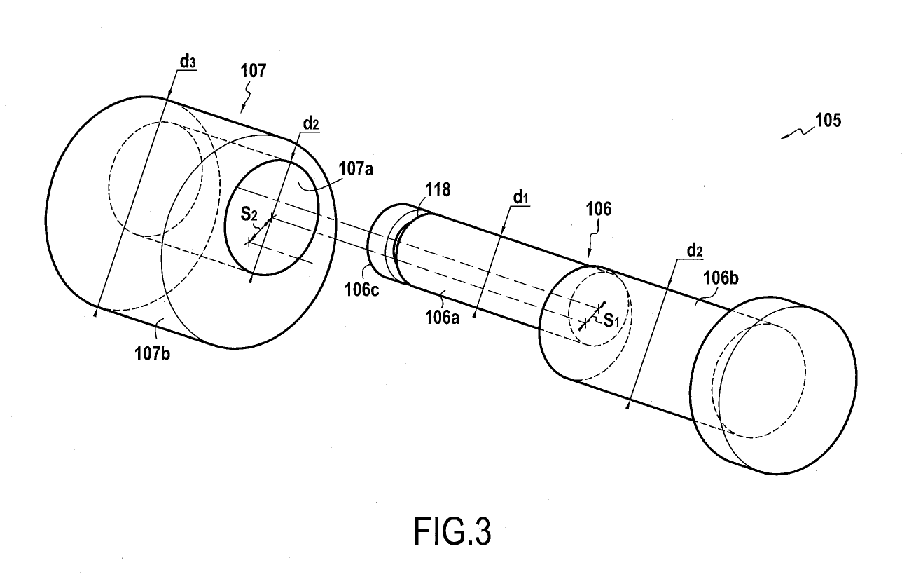

The pin 106 and the bushing 107 may be seen more clearly in FIGS. 2B and 3. Thus, the pin 106 presents two surfaces 106a, 106b that are axisymmetric, and more specifically cylindrical, and that are eccentric relative to each other. Its first surface 106a, which presents a diameter d₁, is to be housed in the radial orifice of a first nozzle segment, specifically in the radial orifice 108 of the ring 109 of the throat 103a, while its second surface 106b, which presents a diameter d₂ that is greater than the diameter d₁ of the first surface 106a, is to be housed inside the bushing 107. The offset s₁ between the axes of the first surface 106a and the second surface 106b is equal to or smaller than the difference between these two diameters d₁ and d₂. The bushing 107 is likewise eccentric, with an internal axisymmetric surface 107a and an external axisymmetric surface 107b, which have axes of symmetry that are substantially parallel and that are offset by a distance s₂. In the embodiment shown, the offset s₁ between the axes of the pin 106 is substantially equal to the offset s₂ between the axes of the bushing 107. Alternatively, they could nevertheless be different.

The second axisymmetric surface 106b of the pin 106 is housed with a small radial clearance inside the inside axisymmetric surface 107a of the bushing 107, in such a manner as to allow relative rotation between these two parts, but without allowing significant relative movement in a direction perpendicular to the axis of rotation. In analogous manner, the first axisymmetric surface 106a of the pin 106 and the outside axisymmetric surface 107b of the bushing 107 are also housed with a small radial clearance respectively inside of the orifice 108 of the ring 109 and inside the corresponding radial orifice 110 of the ring 111.

In order to avoid of the pins 106 being able to escape from the radial orifices 108, the assembly also includes an axial retention member in the form of an annulus 117 fastened by screws 119 to the ring 109 of the throat 103a. Axial projections 117a from the annulus 117 engage in an annular groove 118 around an inside end 106c of each pin 106 projecting from the orifice 108, in order to retain each pin 106.

The connection shown in FIG. 2 may be put into place using the following method:

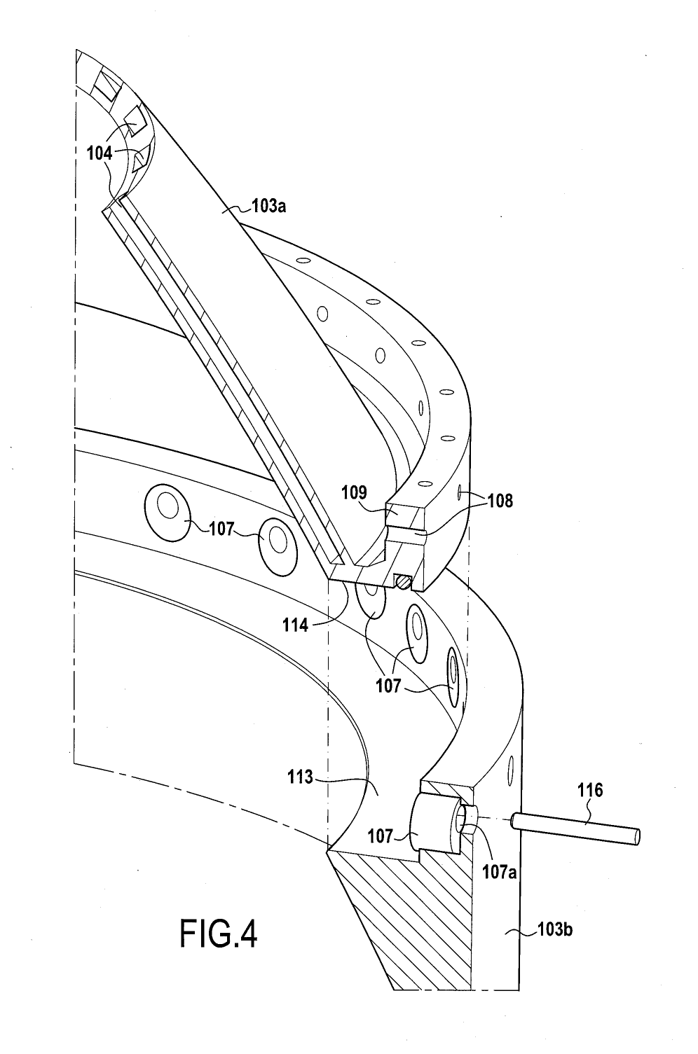

In a first step, the bushings 107 are received inside the radial orifices 110 of the ring 111 of the divergent portion 103b, each coming into abutment against the shoulder 112 of the corresponding orifice 110. Thereafter, the divergent portion 103b is caused to press against the throat 103a as shown in FIG. 4. To do this, three fingers 116 are inserted from the outside in three of the orifices 110 in the ring 111 of the divergent portion 103b. The three fingers 116 may be situated at intervals of 120° in a transverse plane so as to ensure they are mutually balanced, and they exert a prestress force F on the divergent portion 103b. Alternatively, or in addition to these fingers 116, other means may be envisaged for introducing and initially applying this prestress F, such as for example, conventional clamps. The selection of the means for applying prestress depends in particular on the geometry of the two parts caused to press against each other.

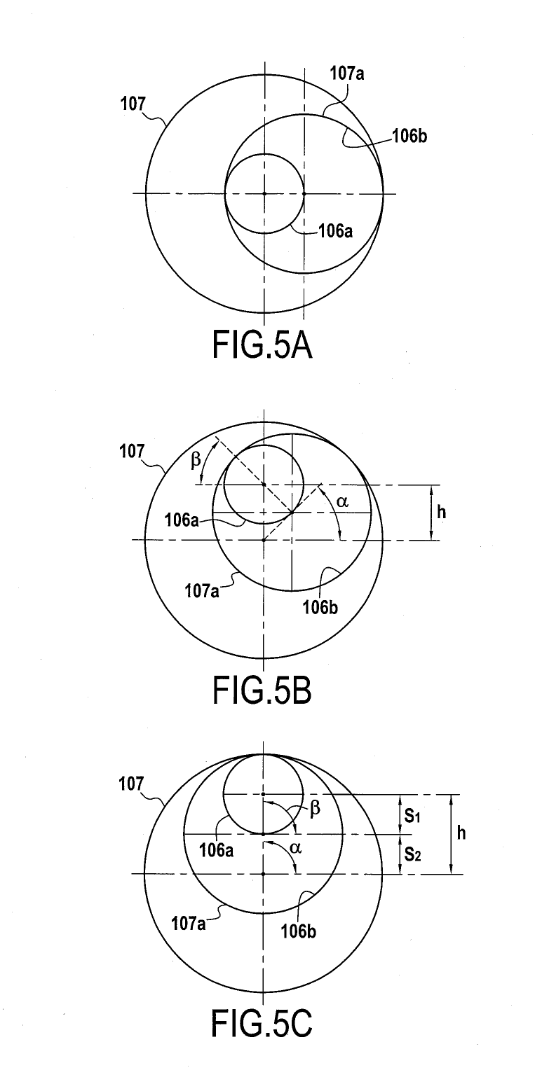

Thereafter, while this prestress F is being maintained between the opposite radial shoulders 113 and 114 of the throat 103a and of the divergent portion 103b, the pins 106 are inserted through the remaining orifices 110. For the purpose of bringing each pin 106 into exact alignment with the corresponding orifice 108 in the ring 109, the pin 106 and the bushing 107 may be turned in the orifice 110 in the manner shown in FIGS. 5A to 5C. As can be seen in the figures, the eccentricity of the pin 106 in the bushing 107, and the eccentricity of the first axisymmetric surface 106a of the pin 106 relative to its second axisymmetric surface 106b make it possible specifically to adjust the position of the first axisymmetric surface 106a vertically by an amount h in the direction of the prestress F using the following formula:

h=s₁ sin α+s₂ sin β

in which the angles α and β are the angles of rotation respectively of the pin 106 and of the bushing 107 starting from the position shown in FIG. 5A. The concept “vertical” is used herein to designate a direction parallel to the central axis of the nozzle 3.

If the offsets s₁ and s₂ are substantially equal, and if the adjustment is purely vertical, as in the example shown, then the angles of rotation α and β will be substantially identical, and the value of the adjustment distance h will comply with the following formula:

h=2s₁ sin α

After insertion of the pins 106 through the orifices 110 that are not occupied by the fingers 116 and into the corresponding orifices 108, the fingers 116 are removed and the pins 106 that have been installed take up the prestress F. The three orifices 110 now released of the fingers 116 may still receive respective pins 106, with their inside ends 106c being put into in alignment with the corresponding orifices 108 in the same manner. Each connection device 105 is self-locking, in the sense that the dimensions of the pin 106 and of the bushing 107, and the coefficients of friction between the various contacting surfaces, are such that neither the prestress F nor the additional stresses during operation of the rocket engine 1 may cause them to turn any more in order to relax the prestress.

Finally, the annulus 117 is put into place, engaging the annular grooves 118 of the pins 106 in order to retain them, and it is fastened to the ring 109 by means of screws 119.

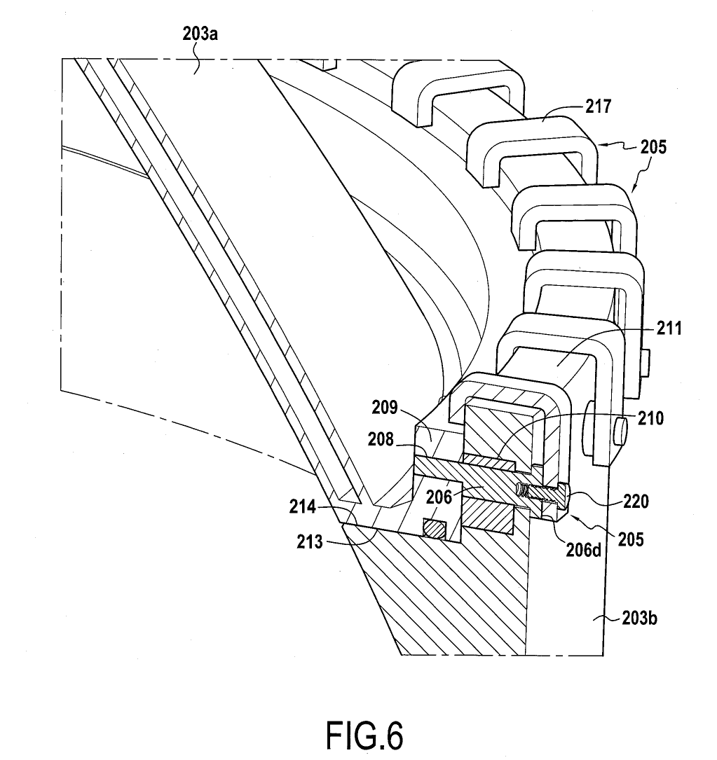

The member for axially retaining the pins may be of a form other than the annulus 117 in this first embodiment. Thus, according to a second embodiment as shown in FIG. 6, each pin 206 is held individually by a bracket 217 bearing against the inside edge of the ring 211 and connected to an outside end 206d of the pin 206 by a screw 220. In the connection method of this second embodiment, each bracket 217 is put into place individually on the ring 211 and thereafter it is connected to the corresponding pin 206. This serves not only to retain the pin 206 axially, but also, given the friction between the head of the screw 220 and the surface of the bracket 217, this serves simultaneously to create additional resistance to rotation of the various elements of the connection device 205 in the orifices 208 and 210 of the rings 209 and 211 after the device has been put into place, thereby maintaining the prestress between the shoulders 213 and 214 of the nozzle segments 203a and 203b. Apart from that, the other elements of this nozzle are equivalent to those of the nozzle of the first embodiment, and they are installed in analogous manner.

Although in the first and second embodiments the ring of the downstream nozzle segment, i.e. of the divergent portion, surrounds the ring of the upstream nozzle segment, this arrangement may also be inverted. In a third embodiment, as shown in FIG. 6, the connection between the throat 303a and the divergent portion 303b of a nozzle also is provided by a series of connection devices 305, each comprising a pin 306 and a bushing 307, the devices being arranged all around the nozzle. As in the first two embodiments, these connection devices 305 maintain prestress F of a radial shoulder 313 of the divergent portion 303b pressing against a corresponding radial shoulder 314 of the throat 303a. A sealing ring 315 between these shoulders 313 and 314 also provides sealing for the connection between the throat 303a and the divergent portion 303b. Nevertheless, in this third embodiment, each pin 306 is housed at one end in a blind radial orifice 308 in the divergent portion 303b, and at the other end inside the bushing 307, which is itself housed in a corresponding radial orifice 310 of a ring 311 of the throat 303a placed around the divergent portion 303b. This radial orifice 310 presents a shoulder 312 against which the bushing 307 comes into abutment. Both the pin 306 and the bushing 307 are eccentric in analogous manner to the pins and the bushings in the two above-described embodiments. Thus, the eccentricity of the pin 306 in the bushing 307, and the eccentricity of the first axisymmetric surface 306a of the pin 306 relative to its second axisymmetric surface 306b make it possible specifically to adjust the position of the first axisymmetric surface 306a vertically by an amount h in the direction of the prestress F in a manner analogous to the first and second embodiments. In this third embodiment, the connection devices 305 do not include axial retention members for retaining the pins 306. Nevertheless, in order to increase the resistance to rotation of the pin 306 and of the bushing 307 after each pin 306 has been adjusted vertically, each pin 306 houses a nut 321 on an outside thread of the outside end 306d of the pin 306. This nut 321 bears against an outside surface 322 of the ring 311 via a washer 323 so as to increase the friction resistance against movement of these various elements of each connection device 305.

Although the present invention is described above with reference to a specific embodiment, it is clear that various modifications and changes may be applied to those embodiments without going beyond the general ambit of the invention as defined by the claims. Furthermore, individual characteristics of the various embodiments mentioned may be combined in additional embodiments. Consequently, the description and the drawings should be considered in a sense that is illustrative rather than restrictive.

1. A device for connecting together a first segment and a second segment of a propulsion nozzle made of materials that are thermally dissimilar, said device comprising at least:
a pin with a first axisymmetric surface that is to be housed in a radial orifice of the first nozzle segment and a second axisymmetric surface that is eccentric relative to said first axisymmetric surface; and
an eccentric bushing presenting an inside axisymmetric surface complementary to the second axisymmetric surface of the pin, and an outside axisymmetric surface, that is eccentric relative to said inside axisymmetric surface and that is to be housed in a radial orifice of the second nozzle segment.

2. A device according to claim 1 having substantially the same radial offset between the axes of symmetry of the inside and outside axisymmetric surfaces of the eccentric bushing as between the axes of symmetry of the first and second axisymmetric surfaces of the pin.

3. A device according to claim 1, further including at least one axial retention member for axially retaining said pin.

4. A device according to claim 3, further including fastener members for fastening said axial retention member to one of said nozzle segments.

5. A device according to claim 1, wherein at least some of said axisymmetric surfaces are cylindrical.

6. A propulsion nozzle comprising:
a first nozzle segment and a second nozzle segment made of thermally dissimilar materials, each having a radial shoulder bearing against a corresponding radial shoulder of the other one of said segments, together with a plurality of radial orifices facing corresponding orifices in the other one of said segments; and
a plurality of connection devices according to claim 1, wherein the first axisymmetric surface of the pin of each of them is housed in one of said radial orifices of the first segment and the eccentric bushing is housed in the corresponding radial orifice of the second segment, the second axisymmetric surface of the pin co-operating with the inside axisymmetric surface of the eccentric bushing.

7. A propulsion nozzle according to claim 6, wherein each eccentric bushing is retained between an outer surface of the first nozzle segment and a shoulder in the radial orifice of the second nozzle segment in which the eccentric bushing is housed.

8. A rocket engine including a propulsion nozzle according to claim 6.

9. A method of connecting together a first segment and a second segment of a propulsion nozzle that are made of thermally dissimilar materials, each of said segments including a plurality of radial orifices, the method comprising the following steps:
inserting eccentric bushings in the radial orifices of the second nozzle segment, each bushing presenting an inside axisymmetric surface and an outside axisymmetric surface that is eccentric relative to said inside axisymmetric surface;
causing a radial shoulder of the first segment to press against a radial shoulder of the second segment, the radial orifices of the first segment being put into register with corresponding orifices among the radial orifices of the second segment; and
inserting pins in the radial orifices, each pin presenting a first axisymmetric surface that is to be housed in a radial orifice of the first nozzle segment and a second axisymmetric surface of the same pin, that is eccentric relative to the first axisymmetric surface and complementary to the inside axisymmetric surface of one of said eccentric bushings, said first axisymmetric surface of the pin being aligned with the radial orifice of the first nozzle segment by turning the pin and the eccentric bushing in the corresponding radial orifice of the second segment.

10. A method according to claim 9, further including a step of installing at least one axial retention member for axially retaining said pins, so as to retain them in the radial orifices of the nozzle segments.

11. A method according to claim 9, wherein prestress is imparted between said segments by external tooling while the radial shoulder of the first segment is being caused to press against the radial shoulder of the second segment.
